(19) United States
(12) Patent Application Publication
(10) Pub. No.: US 2019/0347052 A1
(43) Pub. Date: Nov. 14, 2019

(54) IMAGE PROCESSING APPARATUS, NON-TRANSITORY COMPUTER READABLE MEDIUM, AND METHOD FOR PROCESSING IMAGE

(71) Applicant: FUJI XEROX CO., LTD., Tokyo (JP)

(72) Inventors: Megumi YAMAGUCHI, Kanagawa (JP); Takashi KIKUMOTO, Kanagawa (JP); Shingo TAJIMA, Kanagawa (JP); Daisuke NOGUCHI, Kanagawa (JP); Yoshihiro SASAKI, Kanagawa (JP)

(73) Assignee: FUJI XEROX CO., LTD., Tokyo (JP)

(21) Appl. No.: 16/352,855

(22) Filed: Mar. 14, 2019

(30) Foreign Application Priority Data
May 14, 2018 (JP) 2018-093111

(51) Int. Cl. G06F 3/12

(52) U.S. Cl. CPC G06F 3/1205; G06F 3/1219; G06F 3/1285; G06F 3/1239; G06F 3/1208

(57) ABSTRACT

An image processing apparatus includes a reception unit that receives specification for covering a color of a medium on which printing is to be performed, a generation unit that generates, using the specification, a print job for additional printing, in which a same color is printed plural times, and a control unit that controls a printing process in accordance with the print job generated by the generation unit.

### CROSS-REFERENCE TO RELATED APPLICATIONS

This application is based on and claims priority under 35 USC 119 from Japanese Patent Application No. 2018-093111 filed May 14, 2018.

### BACKGROUND

### (i) Technical Field

The present disclosure relates to an image processing apparatus, a non-transitory computer readable medium, and a method for processing an image.

### (ii) Related Art

Japanese Patent No. 5111227 discloses a printing control apparatus that processes a print job specifying printing in which a plurality of color toners and special toner for adjusting glossiness are used. The printing control apparatus includes determination means for determining, in an image formed on the basis of the print job, whether the sum of the total amount of the plurality of color toners printed and the predetermined amount of the special toner printed exceeds an upper limit of the amount of toner that can be printed by a printing apparatus specified by the print job, dividing means for dividing the print job into a job in which the color toners are used and a job in which the special toner is used in accordance with a ratio of an image area in which the determination means has determined that the sum of the total amount of the plurality of color toners printed and the predetermined amount of toner printed exceeds the upper limit to a whole image, transmission means for transmitting the jobs obtained as a result of the division performed by the dividing means to the printing apparatus, and display instruction means for, when printing based on the job in which the special toner is used is performed, instructing display means of the printing apparatus to display a guide to setting of a print obtained as a result of the job in which the color toners are used in paper feed means of the printing apparatus.

### SUMMARY

When printing is performed on a colored medium, for example, a color of the medium might affect a printed image. In a specific example in which printing is performed on a black medium, a printed image tends to become blackish. For this reason, white is usually printed as an undercoat of a printed image in order to reduce an effect of a color of a medium. In order to further reduce an effect of a color of a medium (e.g., in order to eliminate an effect of a color of a medium), however, white might need to be printed as an undercoat a plurality of times. Such printing operations are called “additional printing”. When it is possible for a user to specify data for covering a color of a medium on which printing is to be performed, for example, a print job needs to be generated every time.

Aspects of non-limiting embodiments of the present disclosure relate to an image processing apparatus, a non-transitory computer readable medium, and a method for processing an image capable of generating, when additional printing is performed, a print job in accordance with specification for covering a color of a medium on which printing is to be performed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image processing apparatus including a reception unit that receives specification for covering a color of a medium on which printing is to be performed, a generation unit that generates, using the specification, a print job for additional printing, in which a same color is printed a plurality of times, and a control unit that controls a printing process in accordance with the print job generated by the generation unit.

### BRIEF DESCRIPTION OF THE DRAWINGS

Exemplary embodiments of the present disclosure will be described in detail based on the following figures, wherein:

FIG. 1 is a conceptual diagram illustrating an example of the configuration of modules according to a first exemplary embodiment;

FIG. 2 is a diagram illustrating an example of a system configuration according to the first exemplary embodiment;

FIG. 3 is a diagram illustrating an example of undercoating;

FIG. 4 is a diagram illustrating an example of additional printing;

FIG. 5 is a diagram illustrating an example of additional printing;

FIG. 6 is a flowchart illustrating an example of a process according to the first exemplary embodiment;

FIG. 7 is a diagram illustrating an example of a screen;

FIG. 8 is a diagram illustrating an example of the data structure of a covering ratio and toner total output profile table;

FIG. 9 is a flowchart illustrating an example of a process according to the first exemplary embodiment;

FIG. 10 is a flowchart illustrating another example of the process according to the first exemplary embodiment;

FIG. 11 is a diagram illustrating another example of the process according to the first exemplary embodiment;

FIG. 12 is a diagram illustrating another example of the process according to the first exemplary embodiment;

FIG. 13 is a diagram illustrating another example of the process according to the first exemplary embodiment;

FIG. 14 is a diagram illustrating another example of the process according to the first exemplary embodiment;

FIG. 15 is a conceptual diagram illustrating an example of the configuration of modules according to a second exemplary embodiment;

FIGS. 16A and 16B are a flowchart illustrating an example of a process according to the second exemplary embodiment;

FIGS. 17A and 17B are a flowchart illustrating another example of the process according to the second exemplary embodiment;

FIG. 18 is a diagram illustrating another example of the process according to the second exemplary embodiment;

FIG. 19 is a diagram illustrating another example of the process according to the second exemplary embodiment; and

FIG. 20 is a block diagram illustrating an example of the hardware configuration of a computer that achieves the first or second exemplary embodiment.

### DETAILED DESCRIPTION

Exemplary embodiments of the present disclosure will be described hereinafter with reference to the drawings.

### First Exemplary Embodiment

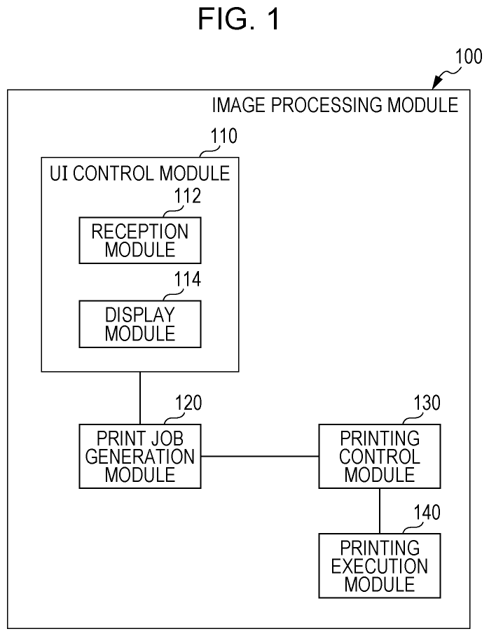

FIG. 1 is a conceptual diagram illustrating an example of the configuration of modules according to a first exemplary embodiment.

A term “modules” generally refers to software (computer program) or hardware components logically separable from one another. That is, the modules in the present exemplary embodiment may be not only modules achieved by computer programs but also modules included in a hardware configuration. The present exemplary embodiment therefore also applies to a computer program (a program for causing a computer to perform steps, a program for causing a computer to function as means, or a program for causing a computer to achieve functions), a system, and a method for achieving these modules. Although “store”, “stored” and other equivalent terms will be used for convenience of description, these terms mean, when an exemplary embodiment implements the present disclosure as a computer program, that the computer program is stored in a storage device or the storage device is controlled in such a way as to store the computer program. The modules may be in one-to-one correspondence with functions, but in practice, one module may be achieved by one program, a plurality of modules may be achieved by one program, or one module may be achieved by a plurality of programs. A plurality of modules may be executed by one computer, or one module may be executed by a plurality of computers in distributed or parallel computing. One module may include another module. In the following description, a term “connection” will be used not only for a physical connection but also for a logical connection (communication of data, issuance of instructions, reference relationships of data, login, etc.). A term “predetermined” will be used when something is determined prior to a target process. The term “predetermined” will be used not only when something is determined prior to a process according to the present exemplary embodiment but also when something is determined prior to a target step in accordance with a situation or a state at the time or a situation or a state so far, even if a process according to the present exemplary embodiment has already started. When there are a plurality of predetermined values, the values may be different from one another or two or more of the values (or all the values, obviously) may be the same. A sentence “If something is A, B is performed” means that it is determined whether something is A, and if so, B is performed. This, however, excludes a case where the determination whether something is A need not be made. In addition, when items are enumerated like “A, B, and C”, these items are enumerated as examples unless otherwise specified, and it is possible that only one of the items (e.g., only A) is selected.

A system or an apparatus may be achieved by a plurality of computers, a plurality of pieces of hardware, a plurality of apparatuses, or the like connected to one another through communication means such as a network (includes a one-to-one connection) or may be achieved by a single computer, a single piece of hardware, a single apparatus, or the like. Terms “apparatus” and “system” will be used as synonyms. Needless to say, the term “system” does not imply a social mechanism (social system), which is based on a human agreement.

Target information is read from a storage device before a process or each of a plurality of processes performed by a module, and a result of the process is written to the storage device after the process is completed. Description of the reading of information from the storage device before a process and the writing of a result to the storage device after a process, therefore, might be omitted. The storage device may be a hard disk, a random-access memory (RAM), an external storage medium, a storage device through a communication line, a register of a central processing unit (CPU), or the like.

An image processing module 100 according to the first exemplary embodiment performs additional printing on a medium and includes, as illustrated in FIG. 1, a user interface (UI) control module 110, a print job generation module 120, a printing control module 130, and a printing execution module 140.

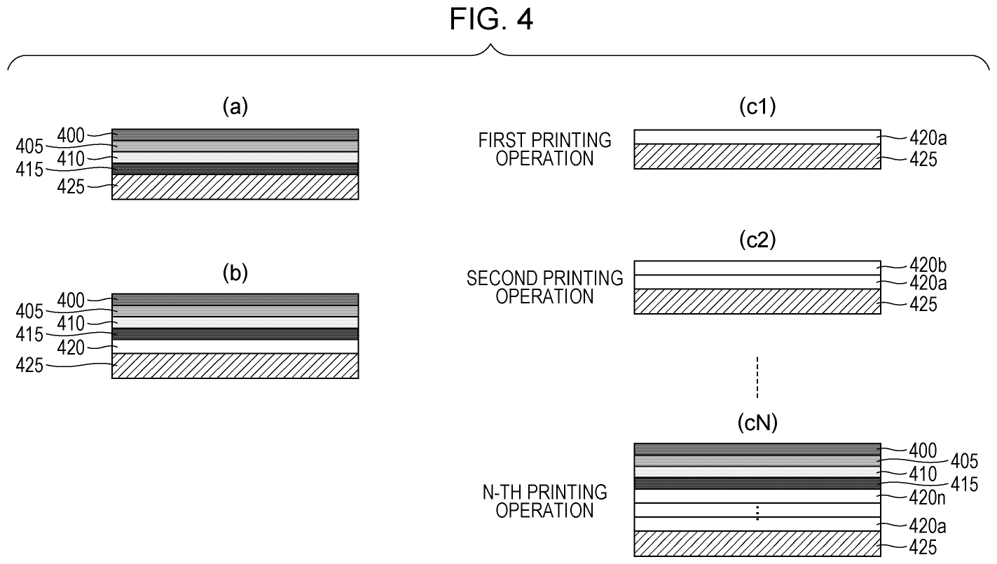

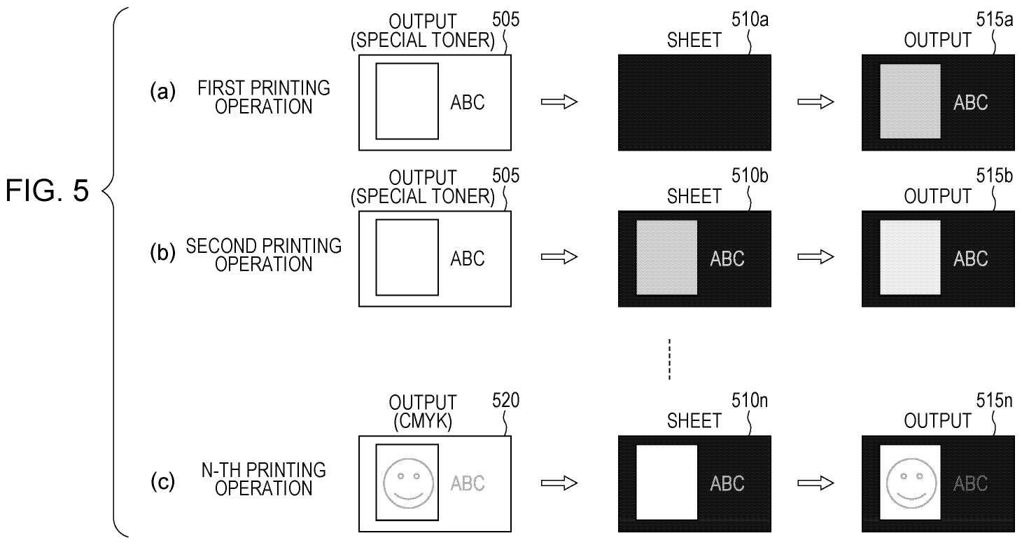

Additional printing will be described in detail later with reference to FIGS. 3 and 4.

A term “medium (also referred to as a recording medium or a print medium)” according to the present exemplary embodiment refers to a medium of any material on which printing can be performed. For example, a medium may be a (transparent) film composed of a synthetic resin, as well as a conventional recording sheet (paper or a sheet).

It is needless to say that a medium different from recording sheets may be set in paper feed means (a sheet feeder, a paper feed tray, a sheet tray, a paper feed cassette, a deck, etc.) (i.e., although a term “paper feed means” includes a word “paper”, a type of medium set in the paper feed means is not limited to paper).

In the present exemplary embodiment, a plurality of printing operations are performed on the same medium. In second and later printing operations, an operator sets, in the paper feed means, a medium on which a previous printing operation has been performed. When the second printing operation is performed, for example, the operator needs to set, in the paper feed means, a medium (sheet) on which the first printing operation has been performed.

The UI control module 110 includes a reception module 112 and a display module 114 and is connected to the print job generation module 120. The UI control module 110 controls a user interface of the image processing module 100.

The reception module 112 receives specification for covering a color of a medium on which printing is to be performed. A user issues an instruction to perform the specification. The user may use, for example, a mouse, a keyboard, a touch panel, a speech sound, a line of sight, or a gesture.

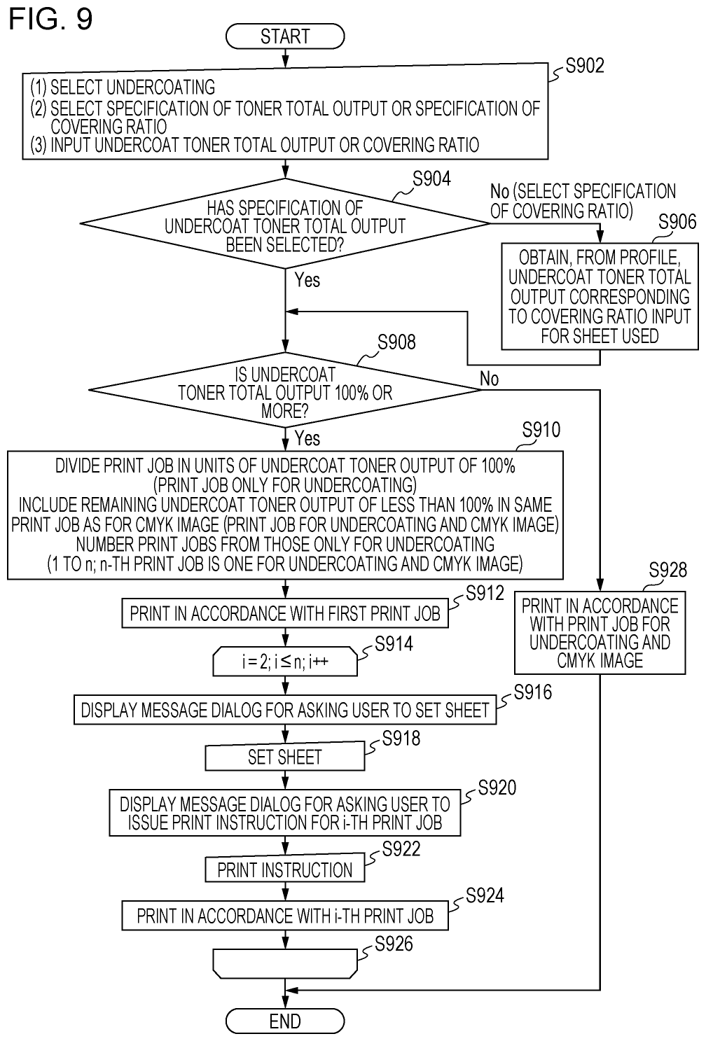

The reception module 112 may receive specification of an output ratio of a color material of a color to be used in additional printing or specification of a covering ratio, which indicates a ratio at which a color of a medium is covered. More specifically, the specification corresponds to an input to a toner total output specification field 715 or a covering ratio specification field 725 on a screen 700, which will be described later with reference to FIG. 7.

The reception module 112 may allow the user to specify a percentage higher than 100% as the output ratio. Although only a percentage equal to or lower than 100% can be usually specified, a percentage higher than 100% can be specified in additional printing. Alternatively, the reception module 112 may prevent the user from specifying a percentage lower than 100%.

The reception module 112 may limit the covering ratio to a percentage equal to or lower than 100%.

The reception module 112 may receive specification of additional printing or the like. This corresponds to a case where, for example, undercoating is specified for additional printing (an undercoating check field 705) on the screen 700 illustrated in FIG. 7 and a percentage specified for the total output or the covering ratio requires a plurality of printing operations.

The display module 114 displays a screen for receiving specification for covering a color of medium on which printing is to be performed. For example, the display module 114 displays a screen on which the output ratio or the covering ratio can be specified. More specifically, the display module 114 displays the screen 700, which will be described later with reference to FIG. 7.

The display module 114 may display a print job generated by the print job generation module 120 such that the user can select the print job.

The display module 114 may also display a name of a print job generated (and named) by the print job generation module 120.

The display module 114 may also display the number of printing operations to be performed in additional printing, a message for asking the user to set a medium in the paper feed means in additional printing, and the like.

The print job generation module 120 is connected to the UI control module 110 and the printing control module 130. The print job generation module 120 generates, using specification received by the reception module 112, a print job for additional printing in which the same color is printed a plurality of times.

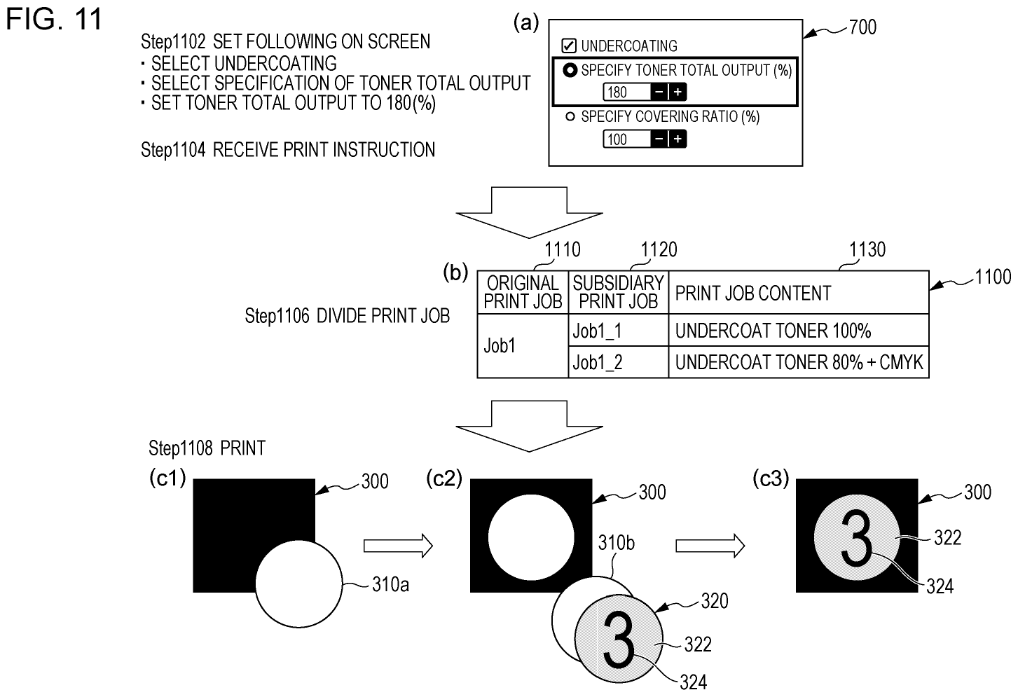

The print job generation module 120 may determine, on the basis of the output ratio, the number of printing operations in additional printing and output ratios in the printing operations. More specifically, the print job generation module 120 may determine the number of printing operations in additional printing by dividing the output ratio by 100 and rounding upwards fractions of a result of the division. The output ratios in the printing operations may be determined such that the output ratio in one printing operation becomes a remainder and the output ratios in the other printing operations become 100. For example, the output ratios in the printing operations other than a final printing operation may be 100, and the output ratio in the final printing operation may be a remainder. More specifically, step S910 in a flowchart of FIG. 9 or the like may be performed.

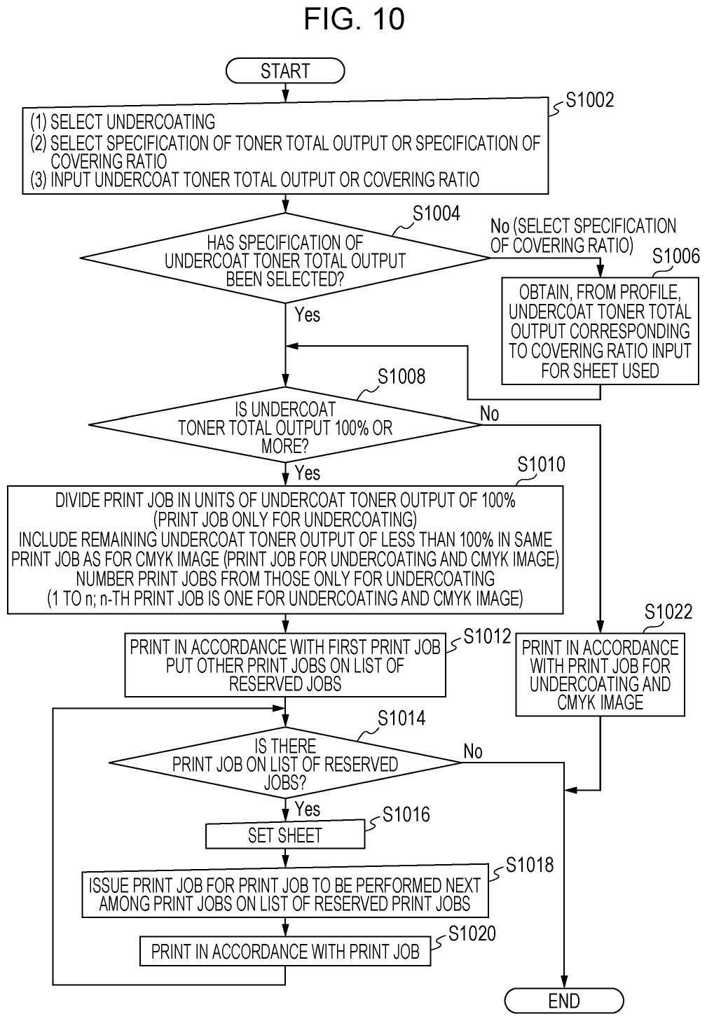

Alternatively, the print job generation module 120 may determine the number of printing operations in additional printing and the output ratios in the printing operations on the basis of an output ratio extracted from a specified covering ratio using storage means (more specifically a covering ratio and toner total output profile table 800 illustrated in FIG. 8, which will be referred to later) storing covering ratios and output ratios for achieving the corresponding covering ratios.

As a name of a print job, the print job generation module 120 may provide a name indicating that a corresponding printing operation is to be performed in additional printing and a number of the printing operation.

The printing control module 130 is connected to the print job generation module 120 and the printing execution module 140. The printing control module 130 controls a printing process performed by the printing execution module 140 in accordance with a print job generated by the print job generation module 120.

Alternatively, the printing control module 130 may control a printing process in accordance with a selected print job in second and later printing operations.

The printing execution module 140 is connected to the printing control module 130. The printing execution module 140 has a function of a printer and performs a printing process. That is, the printing execution module 140 prints print data on a medium in accordance with control performed by the printing control module 130.

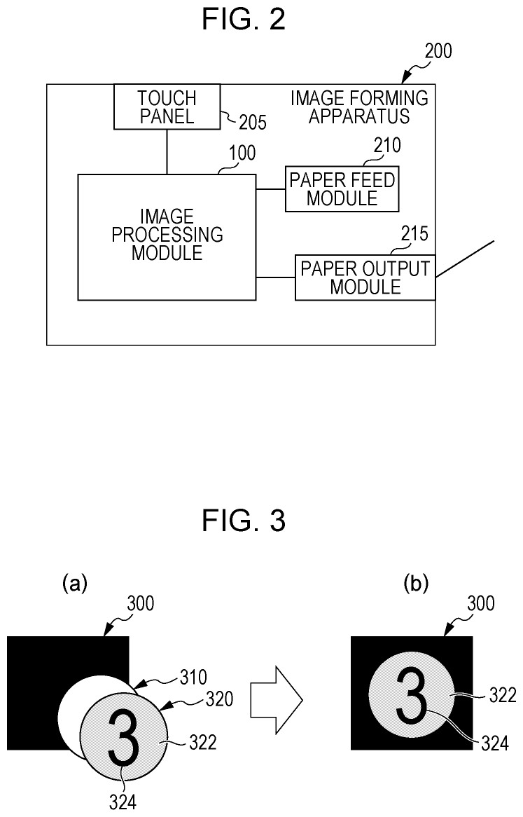

FIG. 2 is a diagram illustrating an example of a system configuration according to the present exemplary embodiment.

An image forming apparatus 200 includes the image processing module 100, a touch panel 205, a paper feed module 210, and a paper output module 215. In this example, the image forming apparatus 200 has a function of the image processing module 100. The image forming apparatus 200 has a function of a printer, a copier, a fax machine, a multifunctional peripheral (an image processing apparatus having at least the function of a printer and also having a function of one or more of a scanner, a copier, a fax machine, and the like), or the like.

The image processing module 100 is connected to the touch panel 205, the touch panel 205, the paper feed module 210, and the paper output module 215.

The touch panel 205 is connected to the image processing module 100. The touch panel 205 receives a user operation and transmits the received user operation to the reception module 112 of the image processing module 100. The touch panel 205 also displays an image for asking the user to set a medium in the paper feed means in additional printing in accordance with control performed by the display module 114 of the image processing module 100. The image provides a guide to setting of a medium.

The paper feed module 210 is connected to the image processing module 100. The paper feed module 210 supplies a medium to the printing execution module 140 of the image processing module 100 in accordance with control performed by the printing execution module 140. In second and later printing operations, the user sets the medium (a medium on which one or more printing operations have been performed).

The paper output module 215 is connected to the image processing module 100. The paper output module 215 outputs a medium on which the printing execution module 140 of the image processing module 100 has performed printing. In second and later printing operations, the user sets a medium output from the paper output module 215 (a medium on which one or more additional printing operations have been performed) in the paper feed module 210. When setting a medium, the user looks at the image displayed on the touch panel 205.

Although the printing execution module 140 of the image processing module 100, the paper feed module 210, and the paper output module 215 are separate modules in the example illustrated in FIG. 2, the printing execution module 140 of the image processing module 100 may include the paper feed module 210 and the paper output module 215, instead.

In the present exemplary embodiment, a print job including an instruction to perform undercoating that employs special toner is divided into a plurality of print jobs, for example, by a printer controller (digital front end (DFE)) including the image processing module 100.

FIG. 3 is a diagram illustrating an example of undercoating.

When printing is performed on a colored medium, an effect of a color of the medium can be reduced (or eliminated) by printing an image using cyan, magenta, yellow, and black (CMYK) toner after undercoating the medium with white toner.

There is an image forming apparatus 200 including a white toner cartridge and CMYK toner cartridges and capable of performing undercoating that employs white toner and printing a CMYK image in a single printing operation.

A specific example will be described with reference to FIG. 3.

A medium 300 is colored (a color other than white), namely black in FIG. 3. A CMYK image 320 to be printed on the medium 300 includes a CMYK image (background) 322 and a CMYK image (number three) 324. The CMYK image (background) 322 is yellow, and the CMYK image (number three) 324 is navy. After white undercoating 310 is performed, the CMYK image (background) 322 and the CMYK image (number three) 324 are printed. As a result, in FIG. 3(b), which illustrates a result of the printing, the CMYK image (number three) 324 remains navy, and the CMYK image (background) 322 remains yellow. That is, an effect of a color (black) of the medium 300 is reduced, and the CMYK image (number three) 324 and the CMYK image (background) 322, which are images to be printed, are reproduced. Without the undercoating 310, the CMYK image (number three) 324 and the CMYK image (background) 322 illustrated in FIG. 3(b) would be blackish navy and blackish yellow, respectively.

When white toner is used to cover a color of a medium like the undercoating 310, the amount of white toner necessary to completely eliminate an effect of a color of a print medium (achieve a covering ratio of 100%) varies depending on the color of the medium.

It might be difficult to achieve a covering ratio of 100% with a single printing operation even if an output ratio of white toner is set to 100%, especially when a color of a medium is dark. For this reason, additional printing, in which a covering ratio of 100% is achieved by repeating a printing operation that employs white toner and then a CMYK image is printed, may be performed. In this case, white toner is output as much as when 100% or more is specified for white toner undercoating.

In the present exemplary embodiment, a covering ratio of a color of a medium in undercoating can be easily set.

A covering ratio of 100% may indicate that an effect of a color of a medium is physically eliminated, but may indicate that an effect of a color of a medium has been reduced enough for a person to feel that a color of a printed image (the CMYK image (background) 322 and the CMYK image (number three) 324 in FIG. 3(b)) is not affected by the color of the medium (the black of the medium 300 in FIG. 3(b)), instead.

Additional printing will be described on the basis of layers of CMYK toner and white toner on a printing surface. FIG. 4 is a diagram illustrating an example of additional printing.

When printing is performed on a colored medium (e.g., a black sheet), an effect of a color of the medium upon CMYK colors can be reduced by printing white toner as an undercoat and then performing printing using CMYK toner. For this purpose, there is a printer including a white toner cartridge or a toner cartridge of a metallic color (e.g., silver) (also referred to as a “special toner cartridge” or a “special color toner cartridge”) as well as CMYK toner cartridges and capable of printing white as an undercoat and CMYK in a single printing operation. That is, printing that employs toner of five colors is performed in a single printing operation. Although white toner is taken as an example of special toner in the present exemplary embodiment, toner of a metallic color may be used, instead.

FIG. 4 will be referred to hereinafter.

As illustrated in FIG. 4(a), when black toner 415, yellow toner 410, magenta toner 405, and cyan toner 400 have been printed on a colored sheet 425, for example, a color of the sheet 425 undesirably affects a whole print. That is, when printing has been performed on the colored sheet 425, resulting tones achieved by the black toner 415, the yellow toner 410, the magenta toner 405, and the cyan toner 400 undesirably become different from intended tones.

As illustrated in FIG. 4(b), therefore, white toner 420 is printed on the sheet 425, and the black toner 415, the yellow toner 410, the magenta toner 405, and the cyan toner 400 are then printed on the white toner 420. The white toner 420 is printed over an area in which the black toner 415, the yellow toner 410, the magenta toner 405, and/or the cyan toner 400 are printed. It is needless to say that the white toner 420 is not printed in an area in which none of the black toner 415, the yellow toner 410, the magenta toner 405, and the cyan toner 400 is printed, and the sheet 425 serves as a background. That is, the whiter toner 420 serves as an undercoat of printing. By printing the white toner 420 first, an effect of the color of the sheet 425 upon printing can be reduced.

When the color of the sheet 425 is dark (e.g., black), for example, it might be difficult to completely eliminate the effect of the color of the sheet 425 with the amount of white toner 420 printed in a single print operation. For this reason, additional printing in which the black toner 415, the yellow toner 410, the magenta toner 405, and the cyan toner 400 are printed after printing the white toner 420 a plurality of times is performed.

As illustrated in FIG. 4(c1), only white toner 420a is printed on the sheet 425 in a first printing operation. Next, the user returns the output sheet 425 (the sheet 425 output from the paper output module 215) to the paper feed module 210 and performs a second printing operation. As a result, as illustrated in FIG. 4(c2), white toner 420b is printed, that is, the white toners 420a and 420b are printed on the sheet 425. In an N-th printing operation, the same printing operation as that illustrated in FIG. 4(b) is performed. The effect of the color of the sheet 425 can thus be reduced, and intended tones can be achieved even on the colored sheet 425.

In the present exemplary embodiment, the number of printing operations in additional printing (N times in FIG. 4) is calculated.

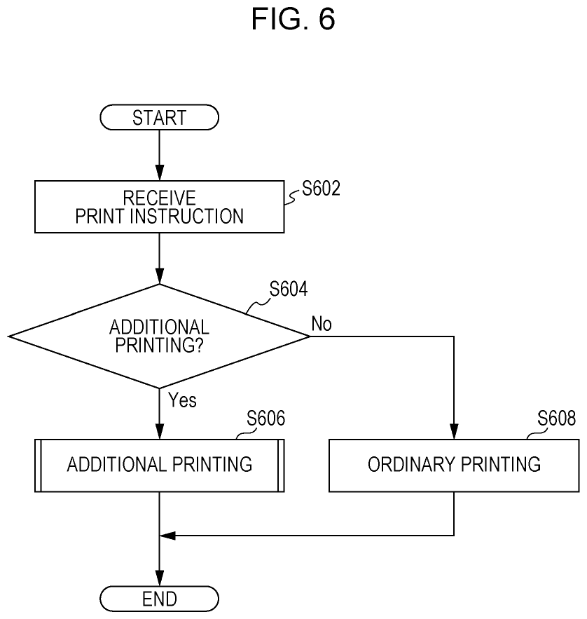

FIG. 5 is a diagram illustrating an example of additional printing.

As illustrated in FIG. 5(c), data to be printed is output data (CMYK) 520. In the output data (CMYK) 520, a color photograph image is provided on the left, and a red text image “A”, a blue text image “B”, and a green text image “C” are provided on the right. The output data (CMYK) 520 is printed on a black sheet 510. For this purpose, output data (special toner) 505 for additional printing is generated from the output data (CMYK) 520. Here, the special toner is white toner, and a contour of the white toner is indicated in black on the output data (special toner) 505 illustrated in FIG. 5(a). That is, the output data (special toner) 505 illustrated in FIG. 5(a) is print data in which areas in which printing is performed in the output data (CMYK) 520 (more specifically, a photograph image area on the left and text image areas of the three letters “A”, “B”, and “C” on the right) are white. The output data (CMYK) 520 may include the output data (special toner) 505. That is, CMYK data may be disposed upon white data in an N-th printing operation (printing that employs both white toner and CMYK toner is performed in a single printing operation).

As illustrated in FIG. 5(a), an output 515a is obtained by printing the output data (special toner) 505 on a sheet 510a. Since a first printing operation that employs white toner has been performed on the output 515a, the photograph image area on the left and the text image areas of the three letters “A”, “B”, and “C” on the right look blackish gray.

The user then sets the output 515a in the paper feed module 210 and specifies a second printing operation. As a result, as illustrated in FIG. 5(b), an output 515b is obtained by printing the output data (special toner) 505 on a sheet 510b (the output 515a illustrated in FIG. 5(a)). Since a second printing operation that employs white toner has been performed on the output 515b in the same areas, the photograph image areas on the left and the text image areas of the three letters “A”, “B”, and “C” on the right look whiter than on the output 515a illustrated in FIG. 5(a). The areas, however, still look gray.

In an N-th (final) printing operation, as illustrated in FIG. 5(c), an output 515n is obtained by printing the output data (CMYK) 520 on a sheet 510n (an output 515 on which (N−1) printing operations have been performed). The special toner (white toner) has been printed on the sheet 510n in the photograph image area on the left and the text image areas on the right repeatedly enough to sufficiently reduce an effect of black on the sheet 510a. On the output 515n, the photograph image area on the left and the text image areas of the three letters “A”, “B”, and “C” on the right (the red text image “A”, the blue text image “B”, and the green text image “C”) are reproduced as if printed on a white medium.

In additional printing, a print that has been subjected to a printing operation needs to be set in the paper feed module 210 in the same direction with a first page thereof directed upward.

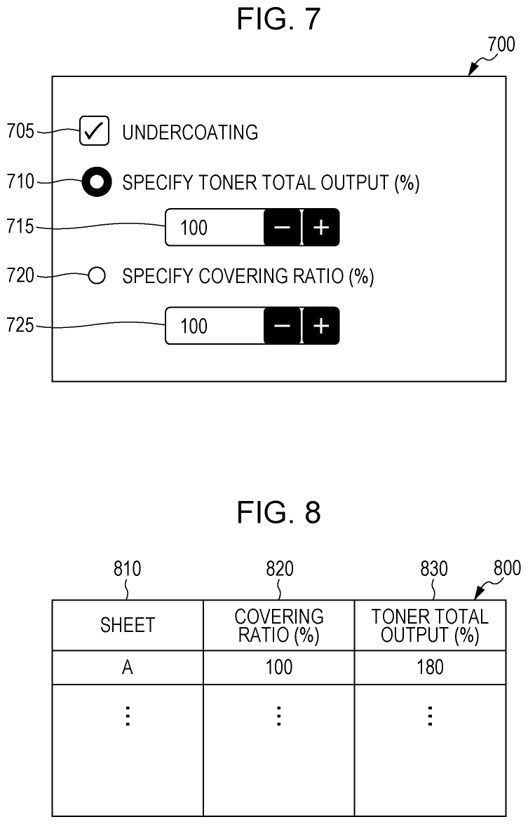

FIG. 6 is a flowchart illustrating an example of a process according to the first exemplary embodiment.

In step S602, the reception module 112 receives a print instruction.

In step S604, whether to perform additional printing is determined. If so, the process proceeds to step S606, and if not (ordinary printing), the process proceeds to step S608.

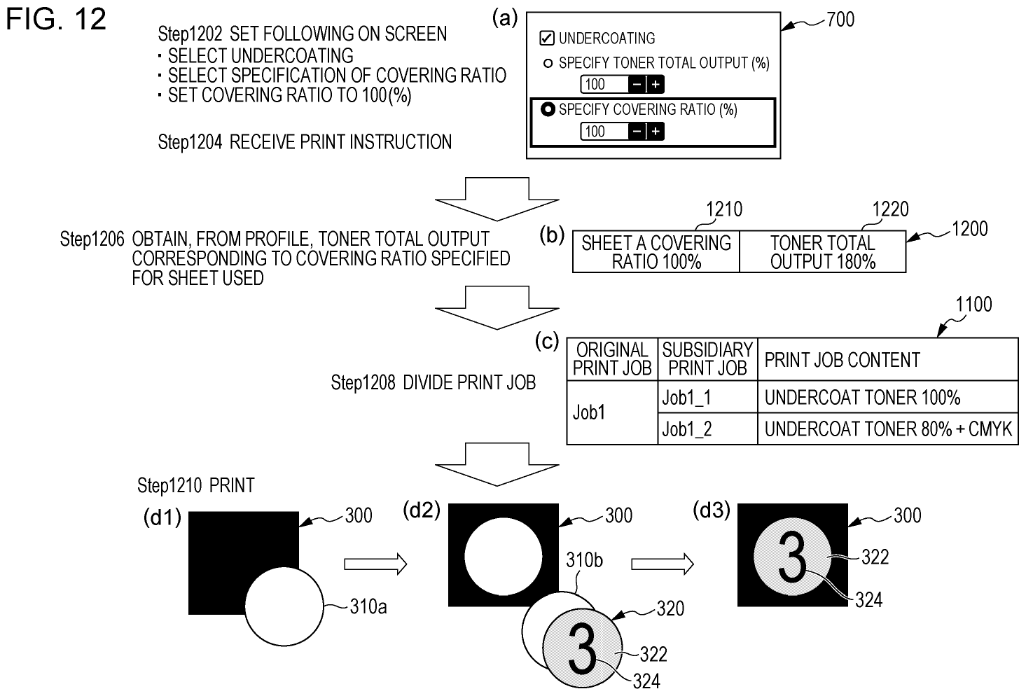

In step S606, the printing execution module 140 performs additional printing. Details of step S606 will be described later with reference to flowcharts of FIGS. 9 and 10.

In step S608, the printing execution module 140 performs ordinary printing. The “ordinary printing” refers to printing in which a medium (output) subjected to printing is not set in the paper feed module 210 and subjected to printing again.

FIG. 7 is a diagram illustrating an example of a screen. The display module 114 displays, on the screen 700 of the touch panel 205, the undercoating check field 705, a toner total output selection field 710, the toner total output specification field 715, a covering ratio selection field 720, and the covering ratio specification field 725. The screen 700 is a screen on which a white toner output ratio of 100% or more can be set. More specifically, the screen 700 includes (1) a setting as to whether to perform undercoating (undercoating check field 705), (2) selection of specification of a toner total output or specification of a covering ratio (the toner total output selection field 710 and the covering ratio selection field 720), (3) a field for inputting a toner total output when the specification of a toner total output has been selected (toner total output specification field 715), and (4) a field for inputting a covering ratio when the specification of a covering ratio has been selected (covering ratio specification field 725).

If the user checks the undercoating check field 705, the toner total output selection field 710 or the covering ratio selection field 720 can be selected. If the user selects the toner total output selection field 710, the user can input a percentage to the toner total output specification field 715. The user can input a percentage higher than 100% to the toner total output specification field 715. In printing (ordinary printing in which only one printing operation is performed) other than additional printing, only a percentage equal to or lower than 100% can be input. Since a plurality of printing operations employing the same white toner is performed in additional printing, a percentage higher than 100% can be input to the toner total output specification field 715. If the user selects the covering ratio selection field 720, the user can input a percentage to the covering ratio specification field 725. Only a percentage equal to or lower than 100% can be input to the covering ratio specification field 725.

FIG. 8 is a diagram illustrating an example of the data structure of the covering ratio and toner total output profile table 800. The covering ratio and toner total output profile table 800 is a profile of correspondences between the covering ratio and the amount of white toner output and has a function of determining the amount of white toner output necessary to achieve a covering ratio for a color of a target medium when the specification of a covering ratio has been selected.

The covering ratio and toner total output profile table 800 includes a sheet field 810, a covering ratio (%) field 820, and a toner total output (%) field 830. The sheet field 810 stores types of sheet. The types of sheet may indicate, for example, colors of sheets and may also indicate materials and/or sizes of sheets. The covering ratio (%) field 820 stores covering ratios (%). The toner total output (%) field 830 stores toner total outputs (%) for achieving corresponding covering ratios for corresponding types of sheet.

A first row of the covering ratio and toner total output profile table 800, for example, indicates that if the covering ratio for a sheet A is 100%, the toner total output needs to be 180%.

FIG. 9 is a flowchart illustrating an example of a process according to the present exemplary embodiment. FIG. 9 illustrates an example of a process at a time when sequential printing is performed in additional printing.

In step S902, the user performs (1) the determination whether to perform undercoating, (2) the selection of the specification of a toner total output or the specification of a covering ratio, and (3) the inputting of an undercoat toner total output or a covering ratio.

In step S904, whether the specification of an undercoat toner total output has been selected is determined. If so, the process proceeds to step S908, and if not (if the specification of a covering ratio has been selected), the process proceeds to step S906.

In step S906, an undercoat toner total output corresponding to the covering ratio input for a sheet used is obtained from the profile (covering ratio and toner total output profile table 800).

In step S908, whether the undercoat toner total output is 100% or more is determined. If so, the process proceeds to step S910, and if not (if one printing operation is enough), the process proceeds to step S928.

In step S910, a print job is divided in units of an undercoat toner output of 100% (print jobs only for undercoating). A remaining undercoat toner output less than 100% is included in the same print job as for a CMYK image (a print job for undercoating and a CMYK image). The print jobs are then numbered from those only for undercoating (1 to n; an n-th print job, which is a final print job, is the print job for undercoating and a CMYK image).

In step S912, printing is performed in accordance with a first print job.

In step S914, a variable i is set to 2. A process up to step S926 is then repeated insofar as i≤n is satisfied. After step S926 ends, the variable i is incremented (increased by 1).

In step S916, a message dialog for asking the user to set the sheet is displayed. That is, the display module 114 asks the user to set, in the paper feed module 210 for a next printing operation, the sheet on which the previous printing operation (step S912 or S924) has been performed.

In step S918, the user sets the sheet.

In step S920, a message dialog for asking the user to issue a print instruction for an i-th print job is displayed. That is, the display module 114 asks the user to issue a print instruction.

In step S922, the user issues a print instruction.

In step S924, printing is performed in accordance with the i-th print job.

In step S926, the process returns to step S914.

In step S928, printing is performed in accordance with the print job for undercoating and a CMYK image. That is, a single ordinary printing operation, not additional printing, is performed. More specifically, the printing operation illustrated in FIG. 4(b) is performed.

FIG. 10 is a flowchart illustrating another example of the process according to the first exemplary embodiment. FIG. 10 illustrates an example of a process for asking the user to select a reserved print job in additional printing.

In step S1002, the user performs (1) the determination whether to perform undercoating, (2) the selection of the specification of a toner total output or the specification of a covering ratio, and (3) the inputting of an undercoat toner total output or a covering ratio.

In step S1004, whether the specification of an undercoat toner total output has been selected is determined. If so, the process proceeds to step S1008, and if not (if the specification of a covering ratio has been selected), the process proceeds to step S1006.

In step S1006, an undercoat toner total output corresponding to the covering ratio input for a sheet used is obtained from the profile (covering ratio and toner total output profile table 800).

In step S1008, whether the undercoat toner total output is 100% or more is determined. If so, the process proceeds to step S1010, and if not (if one printing operation is enough), the process proceeds to step S1022.

In step S1010, a print job is divided in units of an undercoat toner output of 100% (print jobs only for undercoating). A remaining undercoat toner output less than 100% is included in the same print job as for a CMYK image (a print job for undercoating and a CMYK image). The print jobs are then numbered from those only for undercoating (1 to n; an n-th print job, which is a final print job, is the print job for undercoating and a CMYK image).

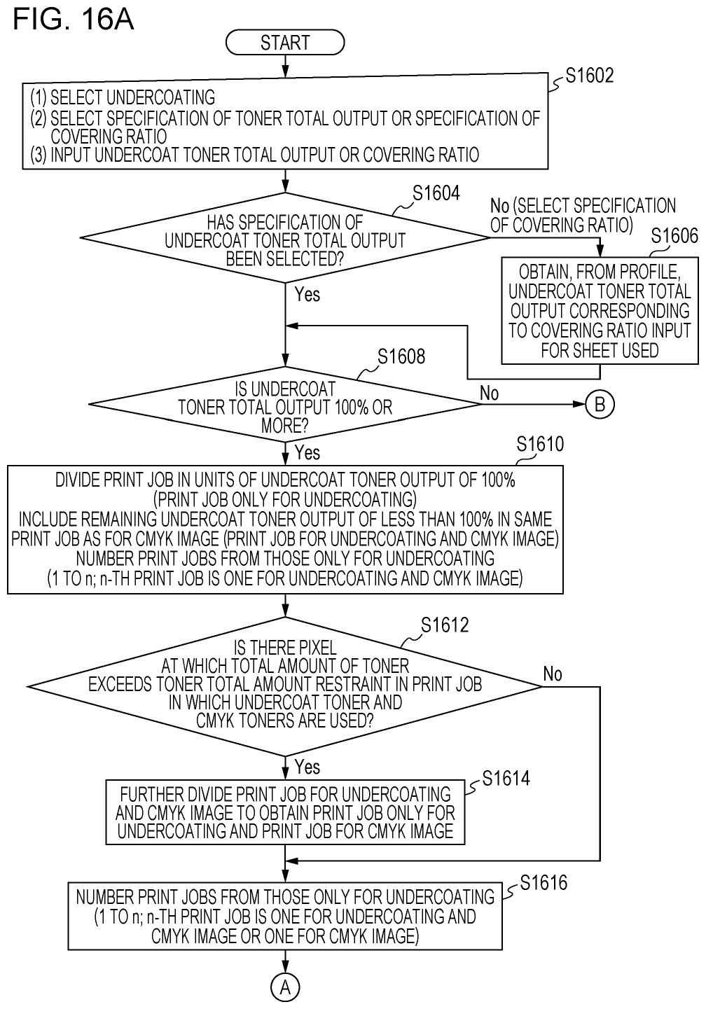

In step S1012, printing is performed in accordance with a first print job. The other print jobs are put on a list of reserved print jobs. A specific example of the list of reserved print jobs is a reserved print job list 1450 illustrated in FIG. 14, which will be referred to later.

In step S1014, whether there are subsidiary print jobs, which are print jobs obtained by dividing the original print job, on the list of the reserved print jobs is determined. If so, the process proceeds to step S1016, and if not, the process ends (step S1099).

In step S1016, the user sets the sheet.

In step S1018, a print instruction for a print job to be performed next among the subsidiary print jobs on the list of the reserved print jobs is issued. The print job to be performed next may be, for example, a print job whose name includes a smallest number.

In step S1020, printing is performed in accordance with the print job, and the process returns to step S1014.

In step S1022, printing is performed in accordance with the print job for undercoating and a CMYK image. That is, a single ordinary printing operation, not additional printing, is performed. More specifically, the printing operation illustrated in FIG. 4(b) is performed.

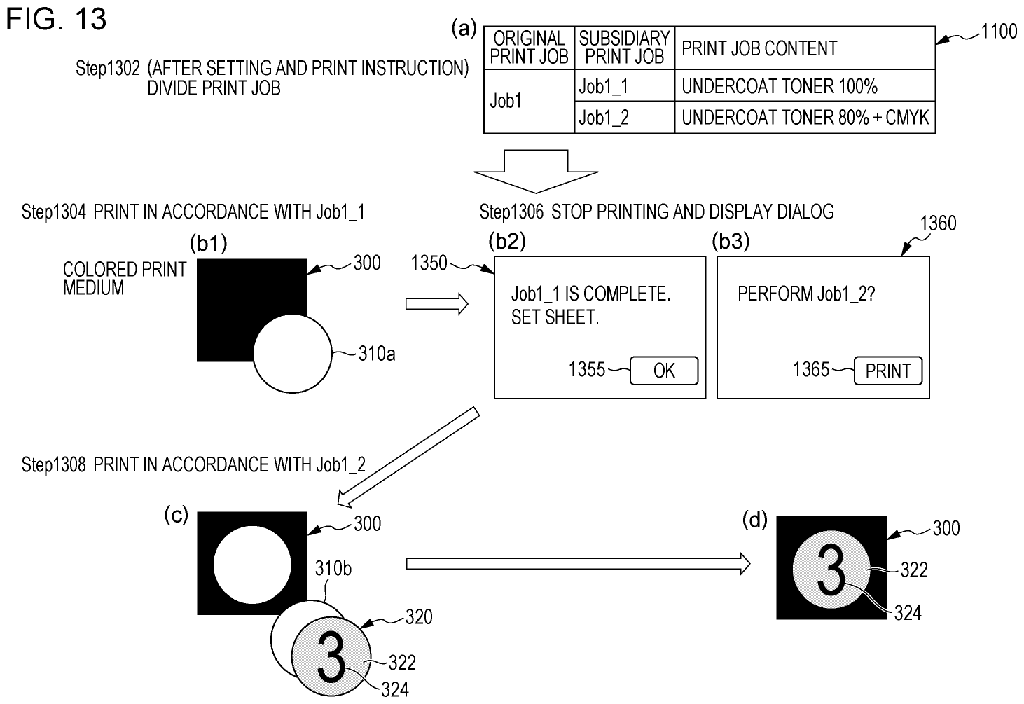

FIG. 11 is a diagram illustrating another example of the process according to the first exemplary embodiment. FIG. 11 illustrates an example of a process at a time when 180% has been specified for a total output of undercoat white toner (YES in step S904 or S1004).

In step S1102, the user performs the following operations on the screen 700 illustrated in FIG. 11(a).
Selects undercoating
Selects specification of a toner total output
Inputs 180(%) as a toner total output

In step S1104, a print instruction issued by the user is received.

In step S1106, a print job is divided. For example, a subsidiary print job table 1100 is generated. FIG. 11(b) is a diagram illustrating an example of the data structure of the subsidiary print job table 1100. The subsidiary print job table 1100 includes an original print job field 1110, a subsidiary print job field 1120, and a print job content field 1130. The original print job field 1110 stores an identifier (ID) of an original print job. The subsidiary print job field 1120 stores IDs of subsidiary print jobs generated from the original print job. The print job content field 1130 stores content of the subsidiary print jobs. In the example illustrated in FIG. 11(b), two printing operations are performed. A first printing operation is printing of a white toner undercoat by 100%. A second printing operation is printing of a white toner undercoat by 80% and CMYK toner.

In step S1108, the printing is performed. In FIG. 11(c1), the first printing operation is performed in accordance with a print job “Job1_1”, and in FIG. 11(c2), the second printing operation is performed in accordance with a print job “Job1_2”. As illustrated in FIG. 11(c3), a medium 300, which is a result of the printing, is output. The second printing operation is performed after the user sets a result (the medium 300 illustrated in FIG. 11(c2)) of the first printing operation in the paper feed module 210.

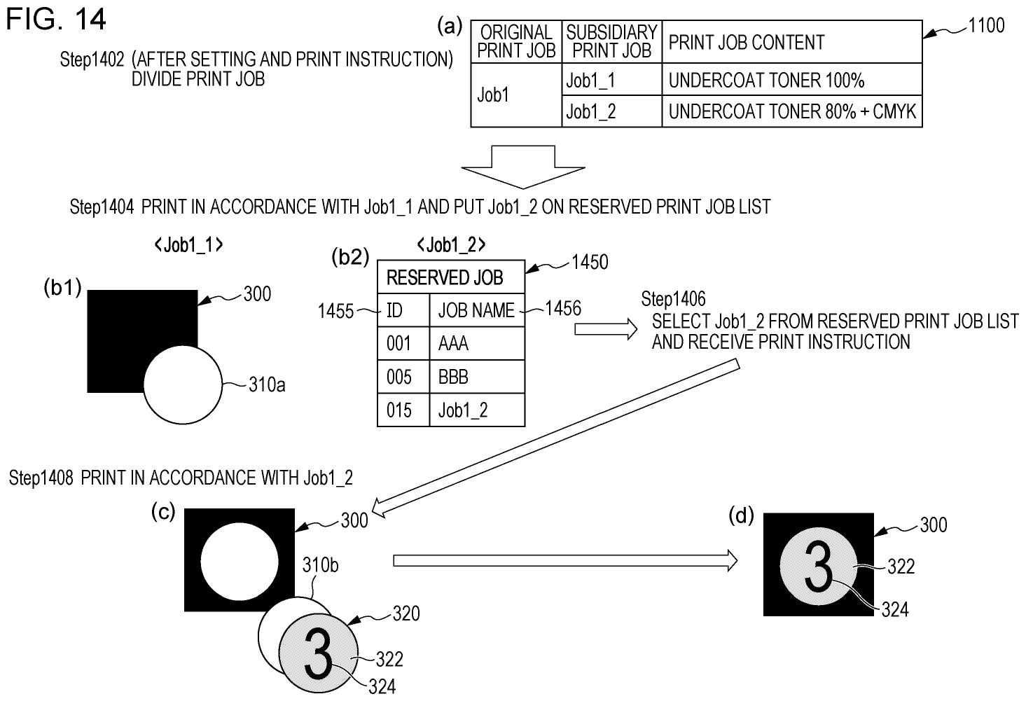

FIG. 12 is a diagram illustrating another example of the process according to the first exemplary embodiment. FIG. 12 illustrates an example of a process at a time when 100% is specified for a covering ratio to be achieved by undercoating (NO in step S904 or S1004).

In step S1202, the user performs the following operations on the screen 700 illustrated in FIG. 12(a).
Selects undercoating
Selects specification of a covering ratio
Inputs 100(%) as a covering ratio

In step S1204, a print instruction issued by the user is received.

In step S1206, a toner total output corresponding to the covering ratio specified for a sheet used is obtained from the profile. A toner total output of 180%, which corresponds to the covering ratio of 100%, is extracted from the covering ratio and toner total output profile table 800 illustrated in FIG. 8. Conversion result information 1200 illustrated in FIG. 12(b) includes pre-conversion information 1210 and post-conversion information 1220. The conversion result information 1200 indicates that the covering ratio of 100% for the sheet A has been converted into the toner total output of 180%.

In step S1208, a print job is divided. For example, a subsidiary print job table 1100 is generated. FIG. 12(c) is a diagram illustrating an example of the data structure of the subsidiary print job table 1100, which is the same as that of the subsidiary print job table 1100 illustrated in FIG. 11(b).

In step S1210, printing is performed. The same printing operations as those illustrated in FIGS. 11(c1) to 11(c3) are performed.

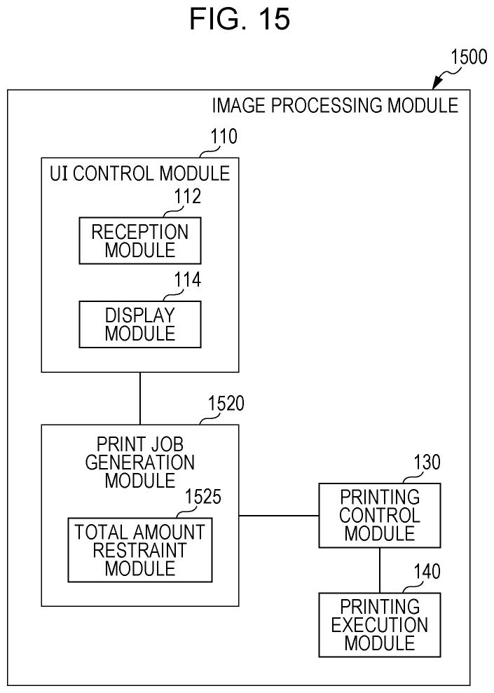

FIG. 13 is a diagram illustrating another example of the process according to the first exemplary embodiment. FIG. 13 illustrates a specific example of a process at a time when subsidiary print jobs are displayed in dialogs and sequentially performed in accordance with the flowchart of FIG. 9.

In step S1302, a print job is divided as indicated by the subsidiary print job table 1100 illustrated in FIG. 13(a). The operation corresponds to step S910.

In step S1304, as illustrated in FIG. 13(b1), printing is performed in accordance with the print job “Job1_1”. This operation corresponds to step S912.

In step S1306, the printing stops and dialogs are displayed. This operation corresponds to steps S916 and S922. More specifically, as illustrated in FIG. 13(b2), a message, “Job1_1 is complete. Set sheet”, is displayed on a screen 1350, and an OK button 1355 is displayed. This operation corresponds to step S916. The user sets, in the paper feed module 210, the sheet on which the printing has been performed. This operation corresponds to step S918. The OK button 1355 is pressed. As illustrated in FIG. 13(b3), a message, “Perform Job1_2?”, is displayed on a screen 1360, and a print button 1365 is displayed. This operation corresponds to step S920. If the print button 1365 is pressed, which corresponds to step S922, the process proceeds to step S1308.

In step S1308, as illustrated in FIG. 13(c), a second printing operation is performed in accordance with the print job “Job1_2”. A medium 300 illustrated in FIG. 13(d), which is a result of the printing operation, is obtained.

FIG. 14 is a diagram illustrating another example of the process according to the first exemplary embodiment. FIG. 14 illustrates a specific example of a process at a time when a subsidiary print job becomes a reserved print job and selected from a list of reserved print jobs to issue a print instruction in accordance with the flowchart of FIG. 10.

In step S1402, as indicated by the subsidiary print job table 1100 illustrated in FIG. 14(a), a print job is divided. This operation corresponds to step S1010.

In step S1404, as illustrated in FIG. 14(b1), printing is performed in accordance with the print job “Job1_1”, and the print job “Job1_2” is put on a reserved print job list 1450 illustrated in FIG. 14(b2). FIG. 14(b2) is a diagram illustrating an example of the data structure of the reserved print job list 1450. The reserved print job list 1450 includes an ID field 1455 and a print job name field 1456. The ID field 1455 stores information (IDs) for uniquely identifying reserved print jobs in the present exemplary embodiment. The print job name field 1456 stores names of the print jobs.

In step S1406, the display module 114 displays content of the reserved print job list 1450. The user selects the print job “Job1_2” from the reserved print job list 1450, and a print instruction is received. When the content of the reserved print job list 1450 is displayed, print jobs for additional printing may be displayed differently from the other print jobs. For example, the print jobs for additional printing may be displayed in red, or may flash. The user can identify a print job to be selected next on the basis of a name of the print job. More specifically, the user can understand that “Job1_2” is a second print job for a first additional printing operation on the basis of a number (“1_2”) at an end of the name of the print job. It is needless to say that a more user-friendly name may be used, instead. For example, “printing operation” may be used as the name of the print job, and “second” may be used to indicate that the print job is a second printing operation. The content of the print job indicated by the subsidiary print job table 1100 may also be added.

In step S1408, as illustrated in FIG. 14(c), a second printing operation is performed in accordance with the selected print job “Job1_2”. A medium 300 illustrated in FIG. 14(d), which is a result of the printing operation, is obtained.

### Second Exemplary Embodiment

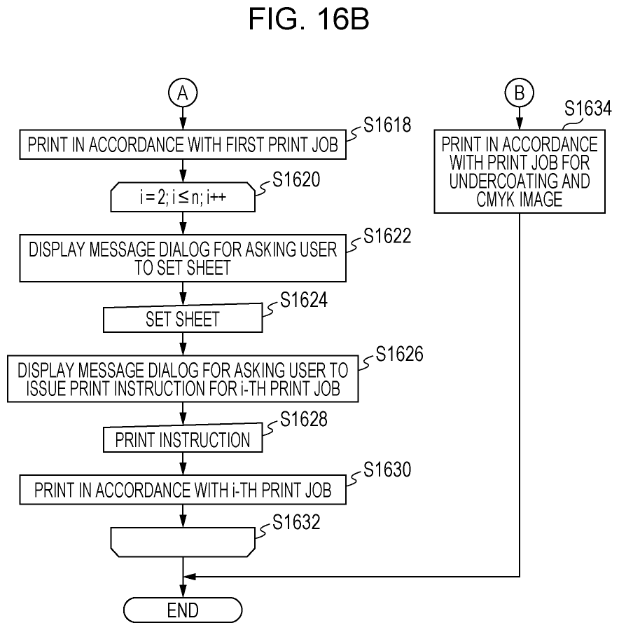

FIG. 15 is a conceptual diagram illustrating an example of the configuration of modules according to a second exemplary embodiment.

An image processing module 1500 includes the UI control module 110, a print job generation module 1520, the printing control module 130, and the printing execution module 140. In the second exemplary embodiment, a process relating to restraint on the total amount of toner is added to the first exemplary embodiment. The second exemplary embodiment, therefore, includes the first exemplary embodiment. The same components as those according to the first exemplary embodiment are given the same reference numerals, and redundant description thereof is omitted.

When white toner is used as an undercoat for covering a color of a print medium, the total amount of CMYK toner might change depending on a tone of a CMYK image even if a white toner output is set to 100%. As a result, the white toner might not be fully output due to the restraint on the total amount of toner. For example, the total amount of CMYK toner becomes large in a part where a tone of a CMYK image is dark, and the amount of white toner output might decrease. If the amount of toner reaches a predetermined percentage (e.g., 260%, etc.) at a certain pixel, for example, a restraining process is performed in order to reduce the amount of toner to the predetermined percentage or lower. The restraint on the total amount of toner is used in a final printing operation of additional printing (a printing operation in which an undercoat and a CMYK image are output).

If an undercoat white toner output remains the same regardless of a tone of a CMYK image as in the first exemplary embodiment, an undercoat might become uneven due to the tone of the CMYK image.

In the second exemplary embodiment, unevenness in an undercoat for covering a color of a medium caused by the restraint on the total amount of toner is suppressed.

The UI control module 110 includes the reception module 112 and the display module 114 and is connected to the print job generation module 1520.

The print job generation module 1520 includes a total amount restraint module 1525 and is connected to the UI control module 110 and the printing control module 130. The print job generation module 1520 has the function of the print job generation module 120 of the image processing module 100 and causes the total amount restraint module 1525 to perform a process for restraining the total amount of toner to be printed.

The total amount restraint module 1525 makes a determination as to the total amount restraint for a final print job.

If there is a pixel at which the total amount of toner is equal to or larger than the predetermined percentage in the final print job, the total amount restraint module 1525 divides the final print job. If the total amount of toner is equal to or smaller than the predetermined percentage at all pixels, the total amount restraint module 1525 does not divide the final print job in order not to increase the number of print operations.

When dividing the final print job, the total amount restraint module 1525 may divide the final print job into a print job for undercoating and a print job for other operations.

More specifically, if there is a pixel at which the total amount of toner, which is obtained by combining the amount of white toner and the amount of CMYK toner together, exceeds the predetermined percentage, the total amount restraint module 1525 divides the final print job using an algorithm, which will be described later, in accordance with a specified white toner output or a white toner output necessary to achieve a specified covering ratio. As a result, even if the total amount of toner, which is obtained by combining the amount of white toner and the amount of CMYK toner together, exceeds the predetermined percentage, a medium can be undercoated without unevenness on the basis of a specified white toner output or a specified covering ratio.

The printing control module 130 is connected to the print job generation module 1520 and the printing execution module 140.

The printing execution module 140 is connected to the printing control module 130.

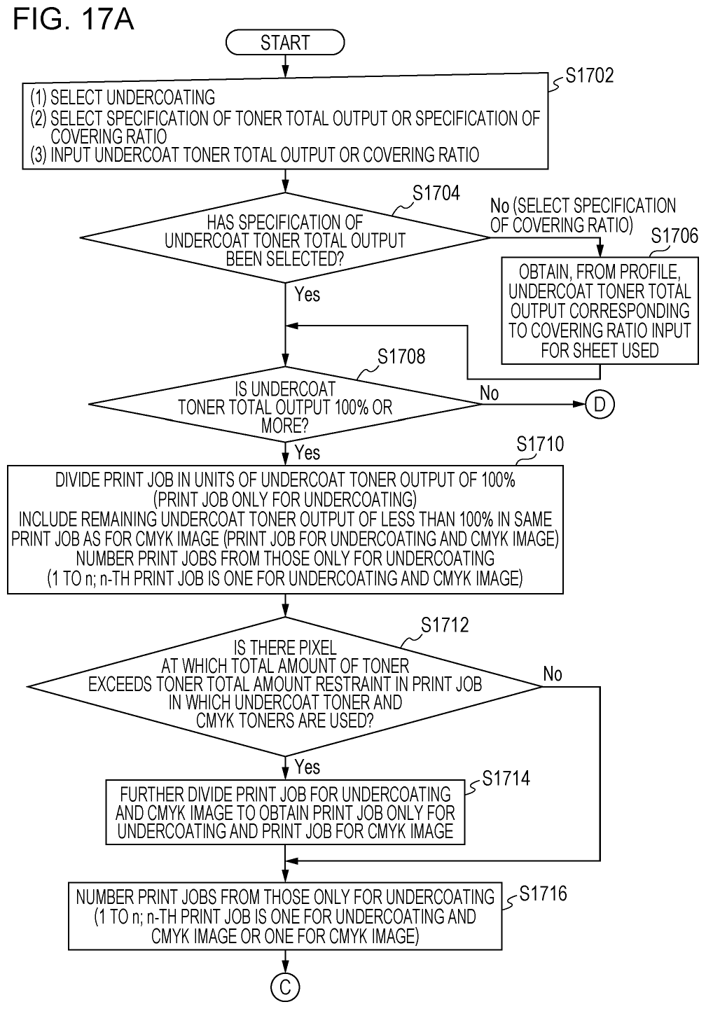

FIGS. 16A and 16B are a flowchart illustrating an example of a process according to the second exemplary embodiment. FIGS. 16A and 16B illustrate an example of a process at a time when sequential printing is performed in additional printing. The flowchart of FIGS. 16A and 16B is different from that of FIG. 9 at steps S1612 to S1616.

In step S1602, the user performs (1) the determination whether to perform undercoating, (2) the selection of the specification of a toner total output or the specification of a covering ratio, and (3) the inputting of an undercoat toner total output or a covering ratio.

In step S1604, whether the specification of an undercoat toner total output has been selected is determined. If so, the process proceeds to step S1608, and if not (if the specification of a covering ratio has been selected), the process proceeds to step S1606.

In step S1606, an undercoat toner total output corresponding to the covering ratio input for a sheet used is obtained from the profile (covering ratio and toner total output profile table 800).

In step S1608, whether the undercoat toner total output is 100% or more is determined. If so, the process proceeds to step S1610, and if not (if one printing operation is enough), the process proceeds to step S1634.

In step S1610, a print job is divided in units of an undercoat toner output of 100% (print jobs only for undercoating). A remaining undercoat toner output less than 100% is included in the same print job as for a CMYK image (a print job for undercoating and a CMYK image). The print jobs are then numbered from those only for undercoating (1 to n; an n-th print job, which is a final print job, is the print job for undercoating and a CMYK image).

In step S1612, whether there is a pixel at which the total amount of toner, which is obtained by combining the amount of undercoat toner and the amount of CMYK toner together, exceeds the predetermined percentage. If so, the process proceeds to step S1614, and if not, the process proceeds to step S1616.

In step S1614, the print job for undercoating and a CMYK image is further divided into a print job only for undercoating and a print job for a CMYK image. That is, the print job is divided so that the total amount of toner in each print job does not exceed the predetermined percentage. More specifically, the number of print jobs only for undercoating that employs white toner is increased.

In step S1616, the print jobs are numbered from those only for undercoating (1 to n; an n-th print job is the print job for undercoating and a CMYK image or the print job for CMYK image).

In step S1618, printing is performed in accordance with a first print job.

In step S1620, the variable i is set to 2. A process up to step S1632 is then repeated insofar as i≤n is satisfied. After step S1632 ends, the variable i is incremented (increased by 1).

In step S1622, a message dialog for asking the user to set the sheet is displayed. That is, the display module 114 asks the user to set, in the paper feed module 210 for a next printing operation, the sheet on which the previous printing operation (step S1618 or S1630) has been performed.

In step S1624, the user sets the sheet.

In step S1626, a message dialog for asking the user to issue a print instruction for an i-th print job is displayed. That is, the display module 114 asks the user to issue a print instruction.

In step S1628, the user issues a print instruction.

In step S1630, printing is performed in accordance with the i-th print job.

In step S1632, the process returns to step S1620.

In step S1634, printing is performed in accordance with the print job for undercoating and a CMYK image. That is, a single ordinary printing operation, not additional printing, is performed. More specifically, the printing operation illustrated in FIG. 4(b) is performed.

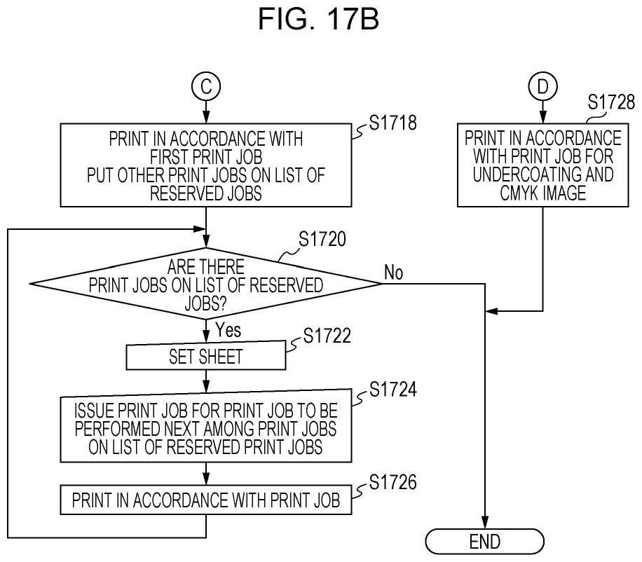

FIGS. 17A and 17B are a flowchart illustrating another example of the process according to the second exemplary embodiment. FIGS. 17A and 17B illustrate an example of a process for asking the user to select a reserved print job in additional printing. The flowchart of FIGS. 17A and 17B is different from that of FIG. 10 at steps S1712 to S1716.

In step S1702, the user performs (1) the determination whether to perform undercoating, (2) the selection of the specification of a toner total output or the specification of a covering ratio, and (3) the inputting of an undercoat toner total output or a covering ratio.

In step S1704, whether the specification of an undercoat toner total output has been selected is determined. If so, the process proceeds to step S1708, and if not (if the specification of a covering ratio has been selected), the process proceeds to step S1706.

In step S1706, an undercoat toner total output corresponding to the covering ratio input for a sheet used is obtained from the profile (covering ratio and toner total output profile table 800).

In step S1708, whether the undercoat toner total output is 100% or more is determined. If so, the process proceeds to step S1710, and if not (if one printing operation is enough), the process proceeds to step S1728.

In step S1710, a print job is divided in units of an undercoat toner output of 100% (print jobs only for undercoating). A remaining undercoat toner output less than 100% is included in the same print job as for a CMYK image (a print job for undercoating and a CMYK image). The print jobs are then numbered from those only for undercoating (1 to n; an n-th print job, which is a final print job, is the print job for undercoating and a CMYK image).

In step S1712, whether there is a pixel at which the total amount of toner, which is obtained by combining the amount of undercoat toner and the amount of CMYK toner together, exceeds the predetermined percentage. If so, the process proceeds to step S1714, and if not, the process proceeds to step S1716.

In step S1714, the print job for undercoating and a CMYK image is further divided into a print job only for undercoating and a print job for a CMYK image. That is, the print job is divided so that the total amount of toner in each print job does not exceed the predetermined percentage. More specifically, the number of print jobs only for undercoating employing white toner is increased.

In step S1716, the print jobs are numbered from those only for undercoating (1 to n; an n-th print job is the print job for undercoating and a CMYK image.

In step S1718, printing is performed in accordance with a first print job. The other print jobs are put on a list of reserved print jobs.

In step S1720, whether there are subsidiary print jobs on the list of the reserved print jobs is determined. If so, the process proceeds to step S1722, and if not, the process ends (step S1799).

In step S1722, the user sets the sheet.

In step S1724, a print instruction for a print job to be performed next among the subsidiary print jobs on the list of the reserved print jobs is issued.

In step S1726, printing is performed in accordance with the print job, and the process returns to step S1720.

In step S1728, printing is performed in accordance with the print job for undercoating and a CMYK image. That is, a single ordinary printing operation, not additional printing, is performed. More specifically, the printing operation illustrated in FIG. 4(b) is performed.

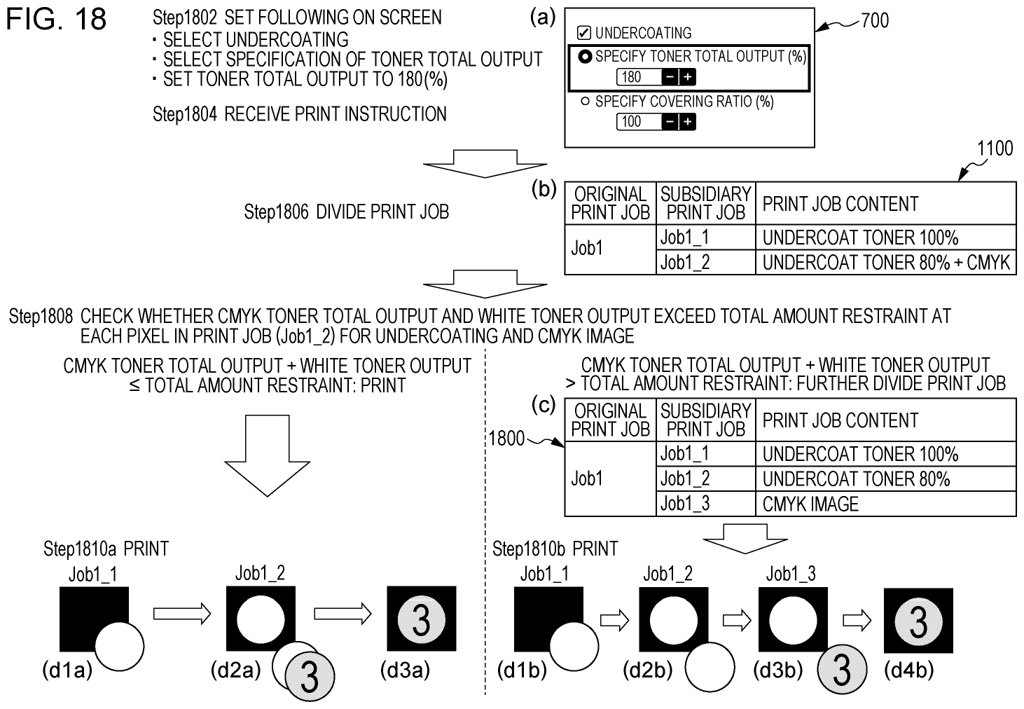

FIG. 18 is a diagram illustrating another example of the process according to the second exemplary embodiment. FIG. 18 illustrates an example of a process at a time when 180% has been specified for a total output of undercoat white toner (YES in step S1604 or S1704) and unevenness in an undercoat is corrected.

In step S1802, the user performs the following operations on the screen 700 illustrated in FIG. 18(a).
Selects undercoating
Selects specification of a toner total output
Inputs 180(%) as a toner total output

In step S1804, a print instruction issued by the user is received.

In step S1806, a print job is divided. For example, a subsidiary print job table 1100 is generated. FIG. 18(b) is a diagram illustrating an example of the data structure of the subsidiary print job table 1100. The data structure of the subsidiary print job table 1100 illustrated in FIG. 18(b) is the same as that of the subsidiary print job table 1100 illustrated in FIG. 11(b).

In step S1808, whether the sum of a CMYK toner total output and a white toner output exceeds the predetermined percentage is determined at each pixel in a print job for undercoat toner and a CMYK image (Job1_2; a final print job in additional printing). If not, the process proceeds to step S1810a. If so, the print job is further divided, and the process proceeds to step S1810b. As a result of the division of the print job, a subsidiary job table 1800 illustrated in FIG. 18(c) is generated. The subsidiary job table 1800 is obtained by dividing the print job (the print job “Job1_2”) in a bottom row of the subsidiary print job table 1100 into two print jobs (a print job “Job1_2” (undercoat toner 80%) and a print job “Job1_3” (CMYK image)).

In step S1810a, printing is performed. That is, as illustrated in FIGS. 18(d1a) to 18(d3a), two printing operations are performed in accordance with the subsidiary print job table 1100 (a print job “Job1_1” and the print job “Job1_2”). More specifically, as illustrated in FIG. 18(d1a), a first undercoating operation (the print job “Job1_1”; undercoat (white) toner 100%) is performed. A result of the undercoating is set in the paper feed module 210, and, as illustrated in FIG. 18(d2a), a combination of a second undercoating operation and a proper printing (the print job “Job1_2”; undercoat (white) toner 80%+CMYK image) is performed. As a result, a print illustrated in FIG. 18(d3a) is obtained.

In step S1810b, printing is performed. That is, as illustrated in FIGS. 18(d1b) to 18(d4b), three printing operations are performed in accordance with the subsidiary job table 1800 (the print job “Job1_1”, the print job “Job1_2”, and the print job “Job1_3”). More specifically, as illustrated in FIG. 18(d1b), the first undercoating operation (the print job “Job1_1”; undercoat (white) toner 100%) is performed. A result of the undercoating is set in the paper feed module 210, and, as illustrated in FIG. 18(d2b), the second undercoating operation (the print job “Job1_2”; undercoat (white) toner 80%) is performed. A result of the undercoating is set in the paper feed module 210, and, as illustrated in FIG. 18(d3b), the proper printing operation (the print job “Job1_3”; CMYK image) is performed. As a result, a print illustrated in FIG. 18(d4b) is obtained. In this example, the printing operation illustrated in FIG. 18(d2a) is divided into the two printing operations illustrated in FIGS. 18(d2b) and 18(d3b).

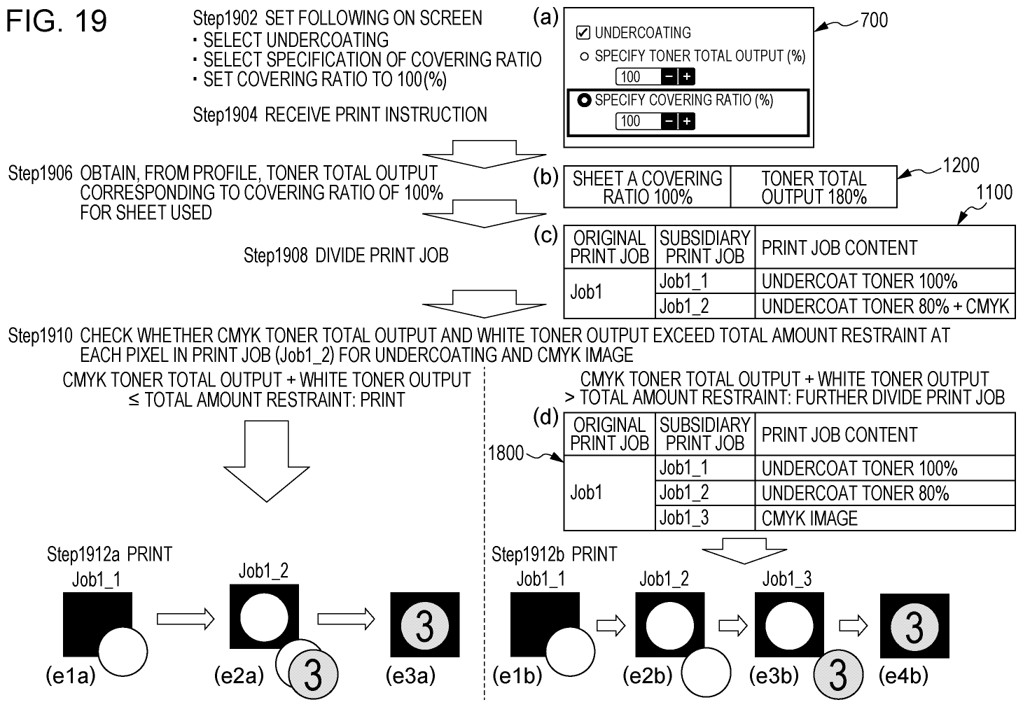

FIG. 19 is a diagram illustrating another example of the process according to the second exemplary embodiment. FIG. 19 illustrates an example of a process at a time when 100% is specified for a covering ratio to be achieved by undercoating (NO in step S1604 or S1704) and unevenness in an undercoat is corrected.

In step S1902, the user performs the following operations on the screen 700 illustrated in FIG. 19(a).
Selects undercoating
Selects specification of a covering ratio
Inputs 100(%) as a covering ratio

In step S1904, a print instruction issued by the user is received.

In step S1906, a toner total output corresponding to the covering ratio of 100% specified for a sheet used is obtained from the profile. A toner total output of 180%, which corresponds to the covering ratio of 100%, is extracted from the covering ratio and toner total output profile table 800 illustrated in FIG. 8. The conversion result information 1200 illustrated in FIG. 19(b) includes the pre-conversion information 1210 and the post-conversion information 1220. The conversion result information 1200 indicates that the covering ratio of 100% for the sheet A has been converted into the toner total output of 180%.

In step S1908, a print job is divided. For example, a subsidiary print job table 1100 is generated. FIG. 19(c) is a diagram illustrating an example of the data structure of the subsidiary print job table 1100, which is the same as that of the subsidiary print job table 1100 illustrated in FIG. 11(b).

In step S1910, whether the sum of a CMYK toner total output and a white toner output exceeds the predetermined percentage is determined at each pixel in a print job for undercoat toner and a CMYK image (Job1_2; a final print job in additional printing). If not, the process proceeds to step S1912a. If so, the print job is further divided, and the process proceeds to step S1912b.

In step S1912a, printing is performed. That is, as illustrated in FIGS. 19(e1a) to 19(e3a), two printing operations are performed in accordance with the subsidiary print job table 1100 (a print job “Job1_1” and the print job “Job1_2”) as in FIGS. 18(d1a) to 18(d3a).

In step S1913b, printing is performed. That is, as illustrated in FIGS. 19(e1b) to 19(e4b), three printing operations are performed in accordance with the subsidiary job table 1800 (the print job “Job1_1”, the print job “Job1_2”, and a print job “Job1_3”) as in FIGS. 18(d1b) to 18(d4b). That is, in this example, the printing operation illustrated in FIG. 19(e2a) is divided into the two printing operations illustrated in FIGS. 19(e2b) and 19(e3b).

### Third Exemplary Embodiment

As described above, in the first and second exemplary embodiments, the image processing module 100 (or the image processing module 1500) divides a print job including an instruction to perform undercoating that employs special toner into a plurality of print jobs.

At this time, an operator (user) of a printer looks at the touch panel 205, which is a display device of the image forming apparatus 200 (the above-mentioned DFE, printer, or the like), to understand how operation specifications that specify the undercoating that employs special toner are to be materialized. In other words, the operator understands that original operation instructions have been changed by the image processing module 100.

In general, operation instructions in a printing workflow are issued through a higher management system (may be an application), but a printing apparatus may be changed (by the higher management system), for example, for error recovery. The image processing module 100, therefore, should change operation instructions on site, and the higher management system should be notified of results of the change.

In order to perform a print job JobA, the operator performs a certain operation on an operation screen of an information processing apparatus (a DFE, the image forming apparatus 200, etc.). In order to complete the print job JobA, the operator needs to operate a printer such that two subsidiary print jobs, namely JobA_1 and JobA_2, are sequentially performed.

In a printing workflow, the operator (worker) performs operations on the basis of a document (operation specifications) that specifies specific operations such as execution of processing in a certain step and transfer of a result of the processing to a next step.

When a print job is divided into a plurality of print jobs, the operator needs to perform operations on the basis of operation instructions relating to JobA_1 and JobA_2, instead of operation instructions relating to an original print job JobA. In a third exemplary embodiment, therefore, a printer (the image forming apparatus 200, a DFE, etc.) that is going to perform the (subsidiary) print jobs JobA_1 and JobA_2 outputs new operation specifications before performing the print jobs. Operation instructions described in the new operation specifications may indicate, for example, dialogs (those described in the first or second exemplary embodiment) displayed on the touch panel 205 of the image forming apparatus 200.

Operation specifications need not necessarily be output from a printer that is going to perform print jobs. Another printer may output operation specifications, or operation specifications may be displayed on a screen of a mobile information terminal such as a smartphone or a notepad, instead.

If the image forming apparatus 200 generates new operation specifications, the image forming apparatus 200 registers the new operation specifications to the higher management system or the application that manages a printing workflow while associating the new operation specifications with original operation specifications. By notifying the workflow management system that the operation specifications have been replaced (and of the new operation specifications), the workflow management system becomes able to identify whether the whole printing workflow is following a scheduled course, whether operation errors have occurred in operation steps, and costs of the operation steps, even if operation instructions have been (urgently) changed on site.

The third exemplary embodiment, therefore, may be implemented as follows.

The image processing module 100 (image processing module 1500) may include an output module that outputs information regarding print jobs generated by the print job generation module 120 (print job generation module 1520).

The output module may output the information to a printing apparatus, a display apparatus such as a display, a terminal apparatus owned by a user, or a management apparatus that manages a workflow corresponding to the print jobs.

The information (information regarding the print jobs generated by the print job generation module 120 (print job generation module 1520)) may be names of the print jobs (data stored in the subsidiary print job field 1120 of the subsidiary print job table 1100), a name of an original print job (a print job before division) (data stored in the original print job field 1110 of the subsidiary print job table 1100), and content of the print jobs (data stored in the print job content field 1130 of the subsidiary print job table 1100).

The output module may output the information regarding the print jobs generated by the print job generation module 120 (print job generation module 1520) as operation specifications for the user. In this case, the information may include a notification indicating that a print obtained as a result of each printing operation is to be set in the paper feed module 210. The information may also include information indicating a direction (a far side, a near side, etc.) in which an image (reduced image) printed on the print is to be set in the paper feed module 210. This is because the user might not know a direction in which the image printed on the print is to be set in the paper feed module 210.

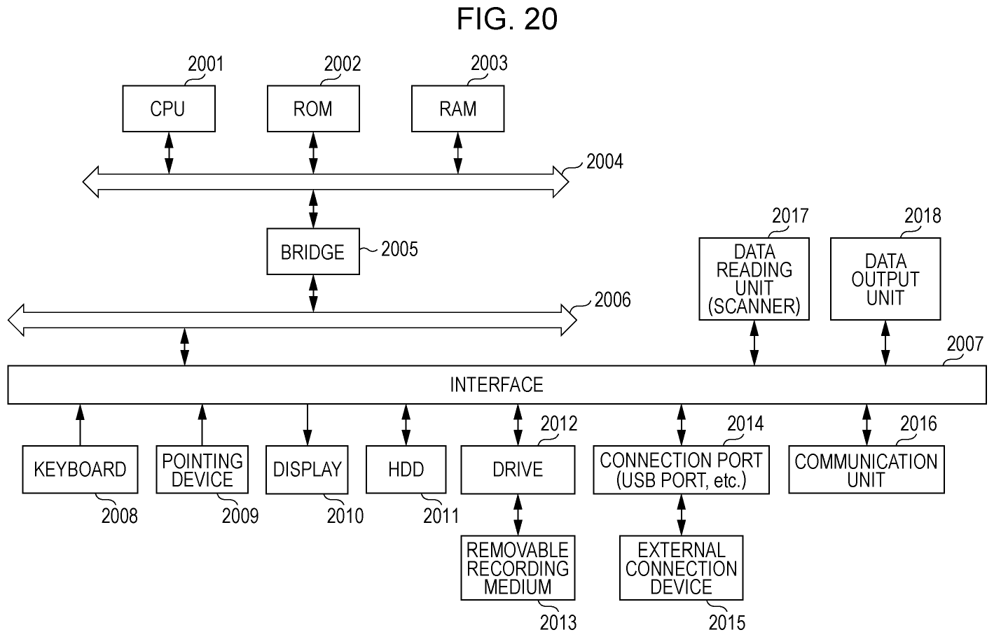

An example of the hardware configuration of an image processing apparatus according to the present exemplary embodiment will be described with reference to FIG. 20. The configuration illustrated in FIG. 20 is achieved, for example, by a personal computer (PC) or the like. FIG. 20 illustrates an example of the hardware configuration including a data reading unit 2017 such as a scanner and a data output unit 2018 such as a printer.

A CPU 2001 is a control unit that performs a process according to a computer program describing execution sequences of the various modules described in the above exemplary embodiments, such as the UI control module 110, the reception module 112, the display module 114, the print job generation module 120, the printing control module 130, the printing execution module 140, the print job generation module 1520, and the total amount restraint module 1525.

A read-only memory (ROM) 2002 stores programs, arithmetic parameters, and the like to be used by the CPU 2001. A RAM 2003 stores a program to be executed by the CPU 2001, parameters that change as the program is executed, and the like. These components are connected to one another by a host bus 2004 such as a CPU bus.

The host bus 2004 is connected to an external bus 2006 such a peripheral component interconnect/interface (PCI) bus through a bridge 2005.

A keyboard 2008 and a pointing device 2009 such as a mouse are devices operated by the operator. A display 2010 may be a liquid crystal display device, a cathode ray tube (CRT), or the like and displays various pieces of information as text and image information. Alternatively, a touch screen having functions of both the pointing device 2009 and the display 2010 may be used. In this case, functions of a keyboard may be achieved by drawing a keyboard (a so-called “software keyboard”, “screen keyboard”, etc.) on the screen (touch screen), instead of physically connecting the keyboard 2008.

A hard disk drive (HDD) 2011 includes a hard disk (or a flash memory, etc.) and drives the hard disk to record or execute a program or information to be executed by the CPU 2001. The hard disk stores print data, print jobs, the covering ratio and toner total output profile table 800, attributes of media, and the like. The hard disk also stores various other pieces of data, various computer programs, and the like.

A drive 2012 reads data or a program recorded on a removable recording medium 2013 inserted thereinto, such as a magnetic disk, an optical disc, a magneto-optical (MO) disk, or a semiconductor memory and supplies the data or the program to the RAM 2003 connected through an interface 2007, the external bus 2006, the bridge 2005, and the host bus 2004. The removal recording medium 2013 may also be used as a data recording area.

A connection port 2014 is used to connect an external connection device 2015 and includes a connection unit such as universal serial bus (USB) port, an Institute of Electrical and Electronics Engineers (IEEE) 1394 port, or the like. The connection port 2014 is connected to the CPU 2001 and the like through the interface 2007, the external bus 2006, the bridge 2005, the host bus 2004, and the like. A communication unit 2016 is connected to a communication line and performs a process for communicating data with the outside. The data reading unit 2017 is a scanner, for example, and performs a process for reading a document. The data output unit 2018 is a printer, for example, and performs a process for outputting document data.

The hardware configuration of the printing process management apparatus illustrated in FIG. 20 is an example, and the present exemplary embodiment is not limited to the configuration illustrated in FIG. 20. Any configuration may be employed insofar as the modules described in the above-described exemplary embodiments can be achieved. For example, some modules may be achieved by dedicated hardware (e.g., an application-specific integrated circuit (ASIC), etc.). In addition, some modules may be provided in an external system and connected by a communication line. In addition, the system illustrated in FIG. 20 may be connected to other systems of the same type by a communication line and operate in combination with the other systems. In addition, the system may be incorporated into a mobile information communication device (a mobile phone, a smartphone, a mobile device, a wearable computer, etc.), an information home appliance, a robot, a copier, a fax machine, a scanner, a printer, a multifunction peripheral (an image processing apparatus having functions of two or more of a scanner, a printer, a copier, a fax machine, and the like), or the like, instead of a PC.

Although a print job is divided if there is even one pixel at which the total amount of toner exceeds the predetermined percentage in the second exemplary embodiment, a print job may be divided if the total amount of toner exceeds the predetermined percentage at a predetermined number of pixels or more, instead. Alternatively, a print job may be divided if the total amount of toner exceeds the predetermined percentage at a certain percentage of pixels or more in an area in which printing is performed.

Terms “equal to or higher than”, “equal to or lower than”, “higher than”, and “lower than” used for comparison in the above exemplary embodiments may be replaced by “higher than”, “lower than”, “equal to or higher than”, and “equal to or lower than”, respectively, insofar as no contradictions are caused.

The program described above may be stored in a recording medium and provided or provided using communication means. In this case, for example, the program may be regarded as constituting a non-transitory computer readable medium storing a program.

A term “non-transitory computer readable medium storing a program” refers to a non-transitory computer readable medium storing a program used to install, execute, or distribute the program.

The non-transitory computer readable medium may be, for example, a digital versatile disc (DVD)-R, a DVD-RW, a DVD-RAM, or the like specified by a DVD forum, a DVD+R, a DVD+RW, or the like specified by DVD+RW, a compact disc read-only memory (CD-ROM), a CD-recordable (CD-R), a CD-rewritable (CD-RW), a Blu-ray Disc (BD; registered trademark), an MO disk, a flexible disk (FD), a magnetic tape, a hard disk, a ROM, an electrically erasable programmable read-only memory (EEPROM), a flash memory, a RAM, a secure digital (SD) memory card, or the like.

The entirety or a part of the program may be recorded in the non-transitory computer readable medium and preserved or distributed. The program may be transferred through a wired network or a wireless network used for a local area network (LAN), a metropolitan area network (MAN), a wide area network (WAN), the Internet, an intranet, an extranet, or the like or a transfer medium such as a combination of these networks. Alternatively, the program may be transmitted on carrier waves.

Furthermore, the program may be a part or the entirety of another program, or may be recorded in a recording medium along with another program. Alternatively, the program may be divided and recorded in a plurality of recording media. In addition, the program may be compressed, encrypted, or recorded in any other mode insofar as the program can be restored.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image processing apparatus comprising:
a reception unit that receives specification for covering a color of a medium on which printing is to be performed;
a generation unit that generates, using the specification, a print job for additional printing, in which a same color is printed a plurality of times; and
a control unit that controls a printing process in accordance with the print job generated by the generation unit.

2. The image processing apparatus according to claim 1,
wherein the specification specifies an output ratio of a color material of a color used in the additional printing or a covering ratio, which indicates a ratio at which the color of the medium is covered.

3. The image processing apparatus according to claim 2,
wherein a percentage higher than 100% is allowed to be input as the output ratio.

4. The image processing apparatus according to claim 3,
wherein the generation unit determines, from the output ratio, a number of printing operations in the additional printing and output ratios in the printing operations.

5. The image processing apparatus according to claim 2,
wherein the covering ratio is limited to a percentage equal to or lower than 100%.

6. The image processing apparatus according to claim 5,
wherein the generation unit extracts, using a storage unit storing covering ratios and output ratios for achieving the corresponding covering ratios while associating the covering ratios and the output ratios with each other, an output ratio from the specified covering ratio and determines, from the extracted output ratio, a number of printing operations in the additional printing and output ratios in the printing operations.

7. The image processing apparatus according to claim 1, further comprising:
a display unit that displays the print job generated by the generation unit in a selectable manner,
wherein, in second and later printing operations, the control unit controls the printing process in accordance with a selected print job.

8. The image processing apparatus according to claim 7,
wherein the generation unit provides, as a name of a print job, a name indicating that a corresponding printing operation is to be performed in the additional printing and a number of the printing operation.

9. The image processing apparatus according to claim 1,
wherein the generation unit makes a determination as to total amount restraint in a final print job.

10. The image processing apparatus according to claim 9,
wherein, if there is a pixel at which a total amount of toner is equal to or larger than a percentage set for the total amount restraint in the final print job, the generation unit divides the final print job.

11. The image processing apparatus according to claim 10,
wherein the generation unit divides the final print job into a print job for undercoating and a print job for other operations.

12. A non-transitory computer readable medium storing a program causing a computer to execute a process for processing an image, the process comprising:
receiving specification for covering a color of a medium on which printing is to be performed;
generating, using the specification, a print job for additional printing, in which a same color is printed a plurality of times; and
controlling a printing process in accordance with the print job generated in the generating.

13. A method for processing an image, the method comprising:
receiving specification for covering a color of a medium on which printing is to be performed;
generating, using the specification, a print job for additional printing, in which a same color is printed a plurality of times; and
controlling a printing process in accordance with the print job generated in the generating.
